(19) United States
(12) Patent Application Publication
(10) Pub. No.: US 2002/0138513 A1
(43) Pub. Date: Sep. 26, 2002

(54) Method for modifying and publishing a web page

(76) Inventors: James Korotney, Walled Lake, MI (US); Kevin E. Bradtke, Royal Oak, MI (US); Brian Terbush, San Francisco, CA (US)

Correspondence Address: CLARK HILL, P.C., 500 WOODWARD AVENUE, SUITE 3500, DETROIT, MI, 48226, US

(21) Appl. No.: 09/816,243

(22) Filed: Mar. 23, 2001

(51) Int. Cl. G06F 17/00

(52) U.S. Cl. 707/511

(57) ABSTRACT

A method for dynamically modifying static web pages is disclosed. The method identifies the type of data being altered. Once identified, a relationship between content data and form data is established. The relationship between the two types of data follows the modifications. A publishing heuristic is employed to record the relationship between the two types of data. Once maintained, any static web page that utilizes the information may be automatically updated. The method eliminates the need for requiring each web page to be dynamically generated automatically with a large number of computer resources or requiring each web page to be manually reviewed and updated, if necessary.

### BACKGROUND OF THE INVENTION

1. Field of the Invention

The invention relates generally to a method for modifying and publishing a web page. More specifically, the invention relates to a method for adding, changing and deleting the content of a web page and publishing that content to all web pages in which the content is found.

2. Description of the Related Art

The Internet has provided a means to obtain all types of data quickly from any location having a computer and access to the Internet. The data can be observed, copied and downloaded for later use. The data may be incorporated into reports, documentation, products, and the like.

For much of the life of the commercial-based use of the Internet, the client-side user was receiving information for use by the client side. All database content, whether structural in terms of web page layout, or content, was provided server-side. As the usage requirements of the Internet became more sophisticated, so did the data entry dynamic. More and more users of Internet data require databases to be able to provide the latest information input therein from either the server side or the client side.

Today, client-side users of databases may add, modify and delete data in the server-side databases. A significant problem with this ability is the integrity of the databases themselves and the integrity of the web pages that were originally generated from the databases. More specifically, data displayed through a web page is oftentimes displayed in multiple web pages. If a user, client-side or server-side, changes the data on one web page, systems must be in place to ensure that any change is updated in every location that the data was stored.

The ability for users to add, modify or delete data, regardless of being client-side or server-side, in an easy, intuitive and complete manner while providing integrity to the complete database system is not currently available. The only currently available solution for this need are expensive systems requiring an extensive understanding of software programming.

### SUMMARY OF THE INVENTION

A method for publishing changed data on a web page includes receiving the changed data. The method then identifies a profile for the data in the database. The profile for the changed data identifies the relationship between the data in the database and the web pages that present the data. The method forwards the changed data and the profile for the changed data to a publishing engine, allowing the publishing engine the ability to publish every web page that uses the changed data with the changed data, based on the profile for the changed data.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a block diagram of a communications network incorporating one embodiment of the invention;

FIG. 2 is an example of one web page published via one embodiment of the invention;

FIG. 3 is a second example of a second web page published via one embodiment of the invention;

FIG. 4 is a third example of a third web page published via one embodiment of the invention;

FIG. 5 is a logic chart of one method incorporating one embodiment of the invention;

FIG. 6 is a data flow chart for changing content data using one embodiment of the invention; and

FIG. 7 is a data flow chart for changing template data using one embodiment of the invention.

### DETAILED DESCRIPTION OF THE PREFERRED EMBODIMENT(S)

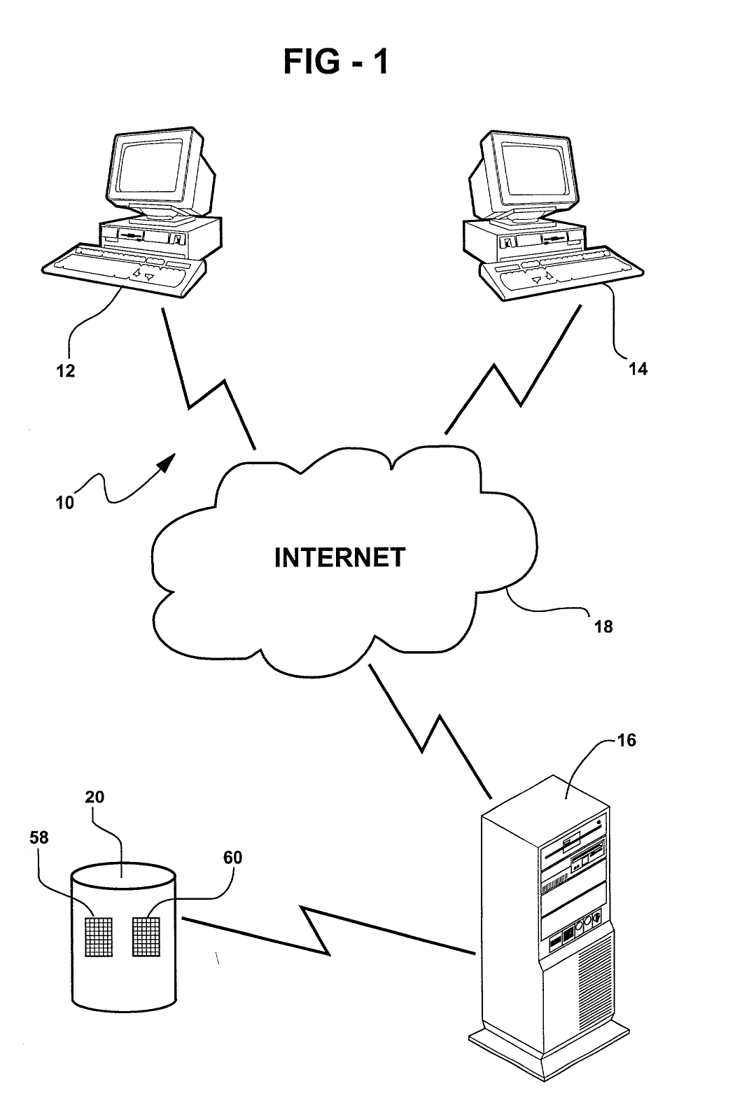

Referring to FIG. 1, a typical communications network is generally shown at 10. The communications network 13 includes two client side computers 12, 14 that are connected to a server side computer 16 through the Internet 18. The server side computer 16 is electrically connected to a database 20. FIG. 1 is shown in a simple environment to illustrate the invention, discussed subsequently. It should be appreciated by those skilled in the art that any number of elements and levels of elements may be incorporated into the communications network 10 without adding an inventive step to the invention. By way of example, the communications network 10 may include a plurality of server side computers 16 as well as a plurality of databases 20. Further, the communications network 10 may exist without one of the elements, e.g., the Internet 18.

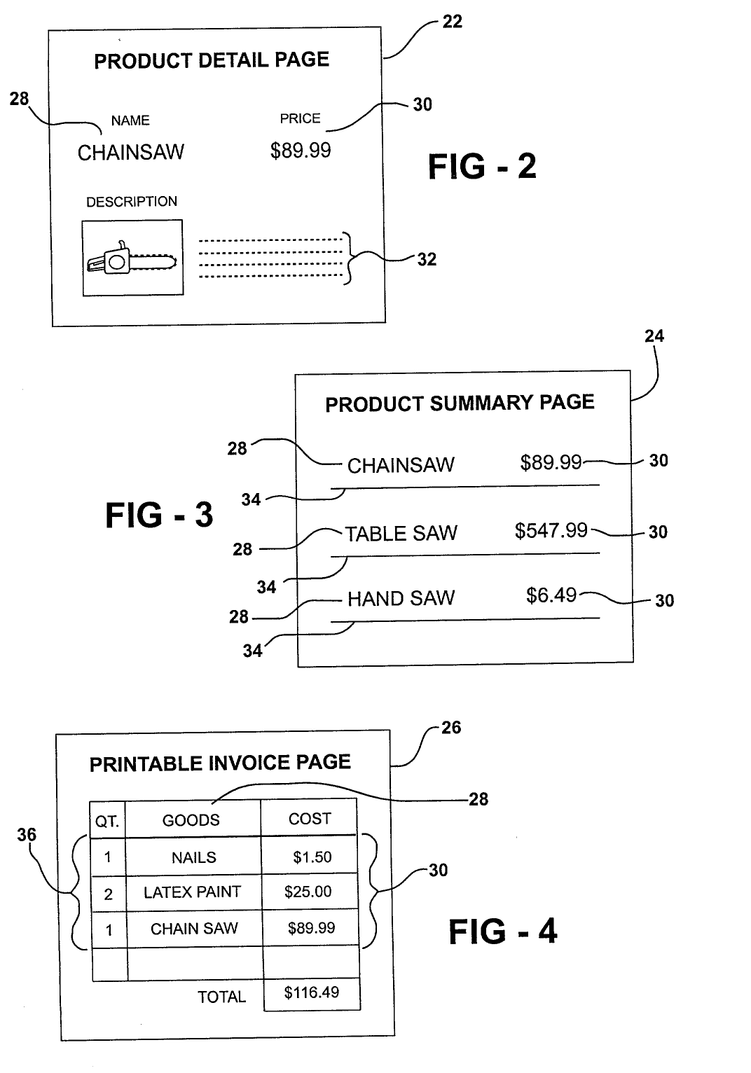

Referring to FIGS. 2 through 4, three web pages 22, 24, 25 that are published using the inventive method are respectively shown. FIG. 2 illustrates a portion of a web page that details a product being offered for sale by an entity. In the example shown, the product is a chainsaw. The web page 22 includes the name 28, a price 30 and product detail 32. These entries define fields or template data. Template data will be discussed in greater detail subsequently. The product detail 32 may include text and graphics as is desired by the entity owning the web page 22.

Continuing with the example shown in FIG. 2, FIG. 3 shows a web page 24 published by the same entity. This web page 24 contains content data differing from that which was presented in first web page 22. The content data 20 is, however, related. More specifically, the product name 28 and price 30 are the same as that of the first web page 22. The description is a product summary 34. The product summary 34 is shorter, allowing more products to be displayed on the web page 24.

The third web page 26, shown in FIG. 4, illustrates yet a third web page format, i.e., the printable invoice page. This web page 26 identifies names 28, prices 30 and quantities 36 being sold.

These web pages 22, 24, 26 all have differing amounts of data found therein. The data is generally separated into two different types. The two types of data are the content data and the template data. Content data includes the information that is retrievable/viewable by the operator of the web site. Content data may include text and graphics, as discussed above, as well as other web assets, e.g., word docs, pdf's and other binaries.

Template data may also be referred to as template definitions. While the template data is typically specific to a particular web page 22, 24, 26, the content data may be used in any number of web pages 22, 24, 26. With reference to the examples shown in FIGS. 2 through 4, the content data identifying the name of the product 28 and the price of the product 30 are used in every web page 22, 24, 26. It is, therefore, very important to ensure that when content data and/or template data is changed, those changes translate to all web pages 22, 24, 26 that utilize that data.

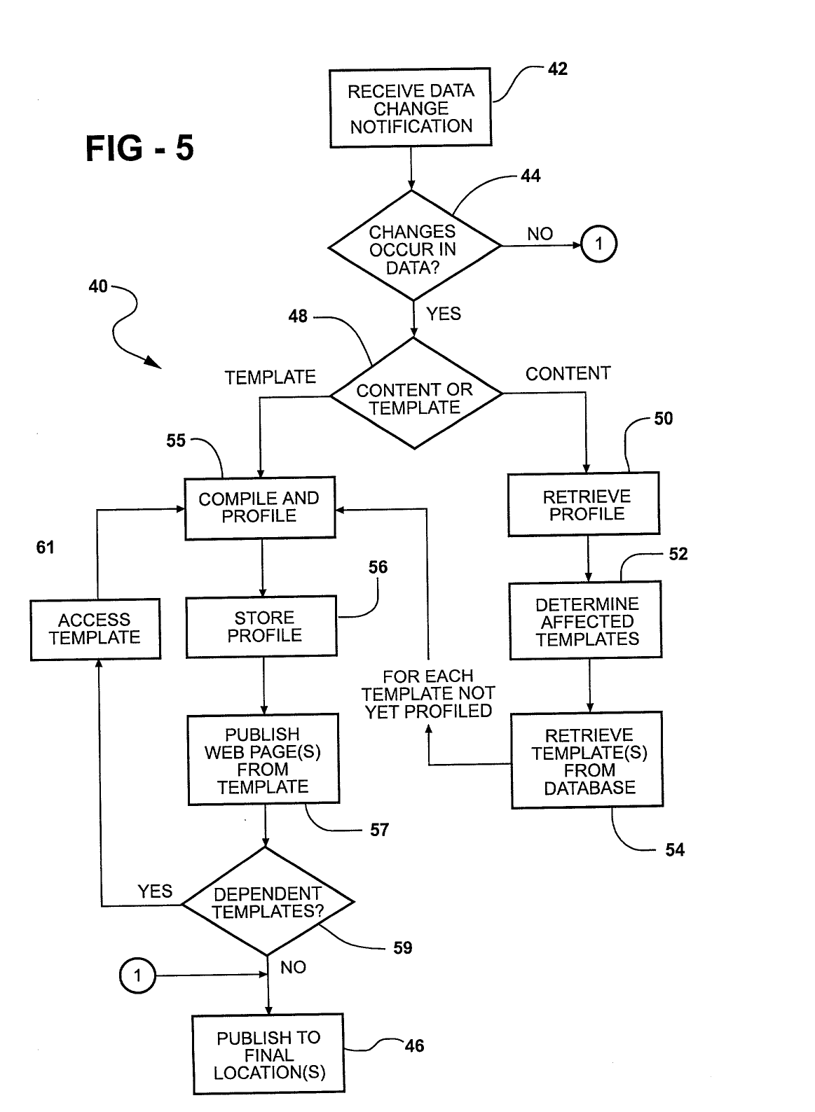

Referring to FIG. 5, the logic flow chart of the inventive method is generally indicated at 40. The method 40 is invoked when a contributor of editable data is adding, changing or deleting information on a web page 22, 24, 25. The method 40 is not invoked when a visitor or user of a web page 22, 24, 26 is merely viewing content for its intended purpose. The method 40 is used exclusively by contributors or managers of the web pages 22, 24, 26 that desire to alter some data.

The method 40 begins by receiving notification of a data change at 42. As stated above, the data being received is data offered by a contributor or manager of the web pages 22, 24, 26 to alter the web pages 22, 24, 26 in some manner. The data may be template data or it may be content data. As used herein, template data is data encoded to create the identity of which content data is associated with a particular web page 22, 24, 26. This is needed because, from time to time, fields, graphics and the like may be changed, renamed, removed, enlarged, etc.

Content data is the data that is informational in nature. It is the data that is found in the fields. In the examples shown in FIGS. 2 through 4, the names of the products, descriptions thereof, and the prices are content data. A single piece of content data can be changed using the inventive method 40 in every web page 22, 24, 26 in which it is displayed. By way of example, the price data in the web page 22 of FIG. 2 may be modified and the modified price will be displayed in the remaining two web pages 24, 26 of FIGS. 3 and 4. By using the inventive method 40, the modified data only has to be entered once and all of the web pages 22, 24, 26 will be modified to publish or display the updated content data automatically.

Once the form and/or content data has been received, it is determined at 44 whether any of the data has been changed. If not, the method 40 is not needed to update the data. Therefore, the data is published on the web pages 22, 24, 26 at 46 and, at this point, the method 40 is terminated until invoked at a later time.

If data has been changed in some manner, it is determined whether the changed data is content data or template data at 48. If the changed data is content data, the profile associated with the changed content data is retrieved at 50. It is then determined which of the templates is affected by the changed content data. This step is performed at step 52. The affected template or templates are then retrieved from the database 20 at 54.

If, however, the changed data is template data, the step following its identification, decision diamond 48, is to compile and profile the changed template data at 55. Once generated, the profile is stored in the database 20 at 56.

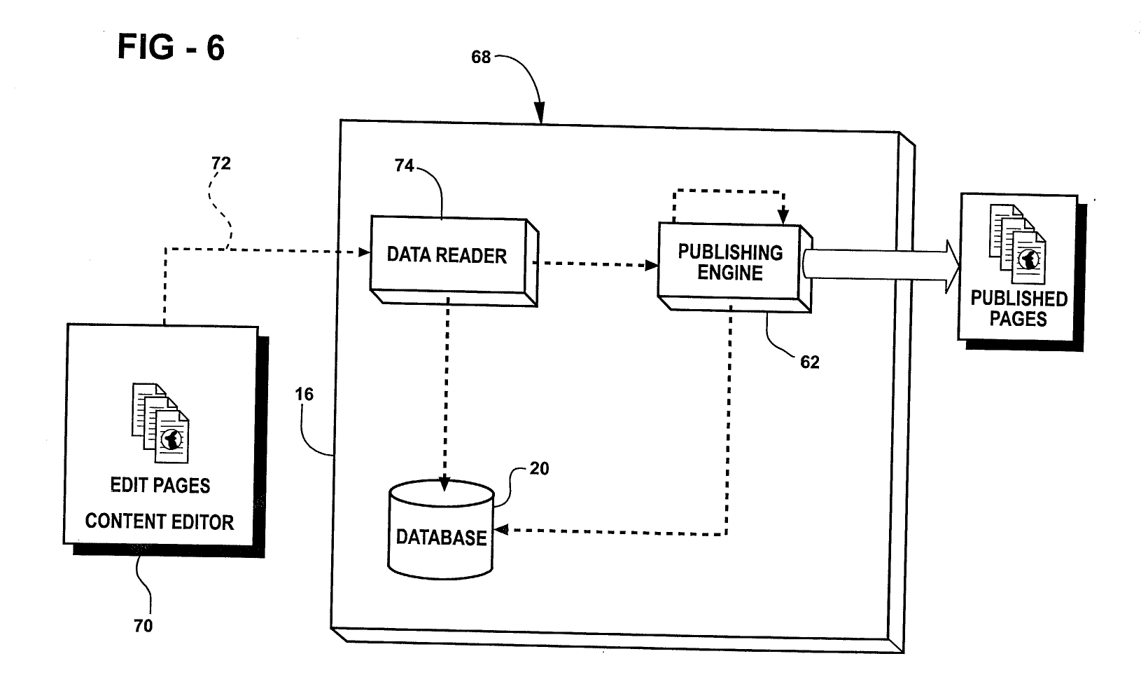

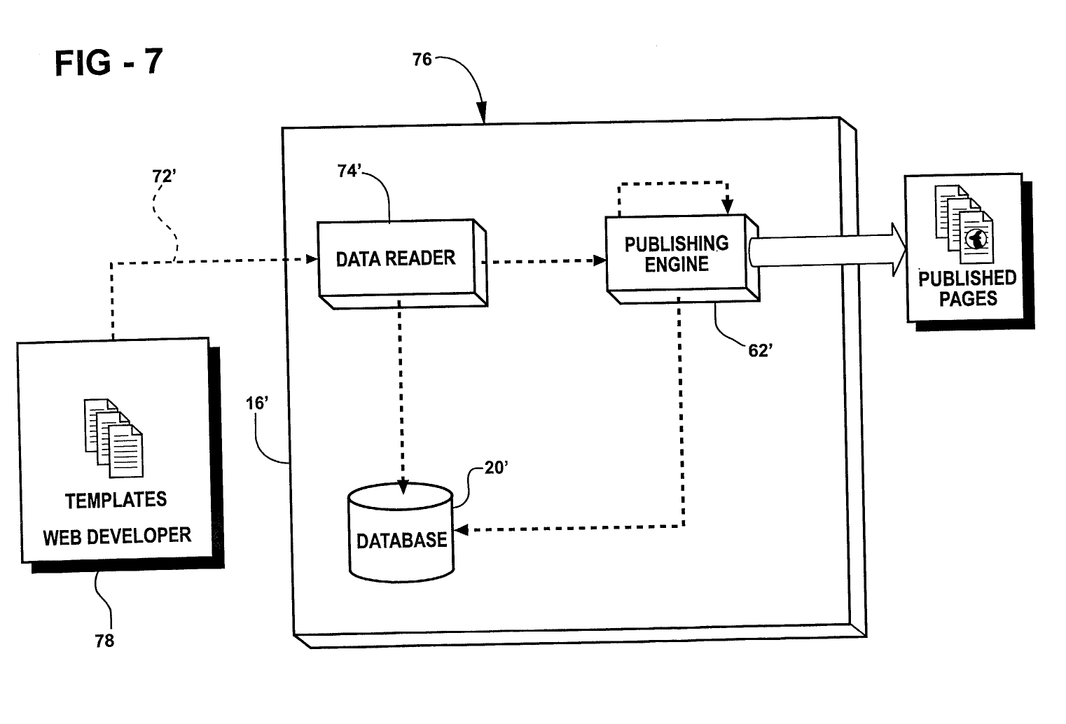

The web page or web pages are then published from the template at 57. Publishing occurs by sending the changed data to a publishing engine 62 (see FIGS. 6 and 7). The content and template data are then published at 46 as static web sites 22, 24, 26 to be viewed by those accessing the data through the communications network 10.

Once published, it is then determined whether dependent template data exist at 59. If so, the dependent template data is accessed from the database 20 at 61. The dependent template data is then compiled and profiled at 55, as was the first changed template data. The storage of the profiles, content and template data occurs in multiple tables 58, 60 found in the database 20. The tables 58, 60 graphically represent the different types of data stored within the database 20. This recursive step of determining whether dependent web sites exist, query 59, ensures the changed data and profiles are updated everywhere. As such, the web site and the resulting pages 22, 24, 26 will always accurately represent the data in the databases 20.

Once all dependent template data has been compiled, profiled and published, the web sites 22, 24, 26 are published in their final locations at 46.

Referring to FIG. 6, a chart of data flow for changes in content data is generally indicated at 68. The content data is changed by a content editor at 70 using the client-side computer 12, 14. The changed content data is received by the server-side computer 16 through some transmission means graphically depicted with a dashed line 72.

Once received by the server-side computer 16, the changed content data is read by data reader 74. The data reader 70 identifies the content that has changed. The data reader 70 forwards the changed content data to the database 20 for storage. The data reader 74 also notifies the publishing engine 62 that content data has been changed.

The publishing engine 62 receives the profiles associated with all of the changed content data. The profiles are stored in the database 20.

Once the profiles are retrieved, the publishing engine 62 is then capable of determining which of the templates the changed data is to be inserted. The templates identify the web pages 22, 24, 25 that need to be updated because they include the templates therein. The publishing engine 62 then republishes the web pages 22, 24, 25 with the changed content data.

Referring to FIG. 7, wherein like primed numerals represent similar elements found in FIG. 6, a chart of data flow for changes in template data is generally indicated at 76. In this scenario, a web developer makes changes in one or more templates at 78. Changes in template data change what types of data are presented on a particular web page 22, 24, 26. By way of example, the product summary page depicted in FIG. 3 may be modified to identify whether a particular product is in stock. The template is changed to send that type of information to the web pages identified by the profile associated with the changed template data.

Once the template data has been changed, the data reader 74′ identifies the changes in the template data. The publishing engine 62′ is notified and, at the same time, the changes in template data are stored in the database 20′. The publishing engine 62′ then generates or modifies the profile associated with the changed template data. The profile is sent to and stored within the database 20′. Subsequently, the web pages 22, 24, 26 are the changed template data.

The invention has been described in an illustrative manner. It is to be understood that the terminology which has been used is intended to be in the nature of words of description rather than of limitation.

Many modifications and variations of the invention are possible in light of the above teachings. Therefore, within the scope of the appended claims, the invention may be practiced other than as specifically described.

We claim:

1. A method for publishing changed data on a web page, the method comprising the steps of:
receiving the changed data;
identifying a profile for the data;
forwarding the changed data and the profile for the changed data to a publishing engine;
identifying the changed data to be published on the web page based on the profile for the data; and
publishing the changed data on the web page based on the profile for the data.

2. A method as set forth in claim 1 including the step of publishing the changed data on a plurality of web pages based on the profile for the changed data.

3. A method as set forth in claim 2 including the step of separating the changed data into content data and template data.

4. A method as set forth in claim 3 wherein the step of identifying the profile for the changed data includes the step of relating the content data with the template data.

5. A method as set forth in claim 4 including the step of using the profile of the content data and the template data to transmit the content data to a portion of the plurality of web pages.

6. A method as set forth in claim 5 including the step of selecting the portion of the plurality of web pages based on the profile of the content data.

7. A method as set forth in claim 5 including selecting the portion of the plurality of web pages based on the profile of the template data.

8. A method as set forth in claim 7 including the step of compiling the template into computer executable form.

9. A method as set forth in claim 8 including the step of executing the template.

10. A method as set forth in claim 9 including the step of processing all of the content data associated with the template.

11. A method as set forth in claim 10 including the recording the content data and the template.

12. A method as set forth in claim 10 including the step of using the content data recorded to complete the step of generating the profile for the data.

13. A method as set forth in claim 10 including the step of using the template recorded to complete the step of generating the profile for the data.

14. A method for displaying a single piece of content data on a plurality of web pages using a client-side computer electrically connected to a server-side computer, the method comprising the steps of:
accessing one of the plurality of web pages with the client-side computer;
identifying template data associated with the 20 content data to be changed;
changing the content data associated with the template data on the one of the plurality of web pages to create changed content data;
transmitting the changed content data to the server-side computer;
creating a profile for the content data and the template data;
identifying the remaining of the plurality of web pages having the template data associated therewith; and
changing the content data related to the template data in the remaining of the plurality of web pages based on the profile for the changed content data with the template data.

15. A method as set forth in claim 14 including the step of transmitting the remaining of the plurality of web pages to the client side computer for viewing.

16. A method as set forth in claim 14 wherein the template data identifies a field within the plurality of web pages that content data may be entered.
